(19) United States
(12) Patent Application Publication
(10) Pub. No.: US 2006/0246745 A1
(43) Pub. Date: Nov. 2, 2006

(54) Fixing device

(75) Inventor: Shao-Che Kao, Keelung City (TW)

Correspondence Address: REED SMITH LLP, Suite 1400, 3110 Fairview Park Drive, Falls Church, VA, 22042, US

(73) Assignee: SmartAnt Telecom Co., Ltd.

(21) Appl. No.: 11/411,955

(22) Filed: Apr. 27, 2006

(30) Foreign Application Priority Data
Apr. 27, 2005 (TW) 94206647

(51) Int. Cl. H01R 12/00

(52) U.S. Cl. 439/60

(57) ABSTRACT

A fixing device is provided, wherein a plurality of elastic arms are disposed on a body along a horizontal direction, a plurality of hooks are disposed on the body along a vertical direction, and a holding block protrudes from a front end of each of the elastic arms. When each of the hooks passes through a fastening hole of a plate and snaps an opposite surface of the plate, each elastic arm pushes the holding block with the elastic force, such that the holding block presses against the plate to generate an elastic clamping effect for clamping the plate between the front ends of the hooks and the holding block, and thereby a gap between the plate and the body is compensated so that the fixing device fastens firmly with the plate.

### CROSS-REFERENCE TO RELATED APPLICATIONS

This non-provisional application claims priority under 35 U.S.C. § 119(a) on Patent Application No(s). 094206647 filed in Taiwan, R.O.C. on Apr. 27, 2005, the entire contents of which are hereby incorporated by reference.

### BACKGROUND OF THE INVENTION

1. Field of Invention

The present invention relates to a fixing device, and more particularly to a fixing device fastened firmly with a plate through a clamping and snapping effect.

2. Related Art

Currently, when an object, for example, a decoration item, a signal wire, or a antenna is to be mounted on a surface of a plastic plate used in an electronic product, a household appliance, or a vehicle, or when two plates are to be fastened together, a fixing device is usually employed to be inserted into a fastening hole dug on the plate, and then the object to be mounted is fastened on the fixing device, so as to be mounted on the surface of the plate. Two plates are fastened together in a similar way, wherein a fastening hole is correspondingly dug on each of the two plates respectively, and then the fixing device is inserted into the two fastening holes, such that the two fastening plates are fastened together.

A conventional fixing device is generally a two-piece combination with a male fastener and a female fastener, wherein the male fastener passes through the fastening hole; then the male fastener is fastened by the female fastener at the opposite surface of the plate, such that the male fastener and the female fastener are clamped with the plate to achieve a fixing effect. If the plate is a part of an enclosed housing, the fastening between the male fastener and the female fastener must be completed before enclosing the housing. When the fixing device will to be replaced in the future, the enclosed housing has to be detached to replace the male fastener and the female fastener at either side of the plate. An improved method invovles: digging a tightening hole on the top surface of a bar; putting the bar into the fastening hole; then pushing a tightening part into the tightening hole to enable the bar to be spread and extended, such that a tight fitting connection occurs between the bar and the fastening hole. However, although the installation process in this method is conducted on one surface of the plate, both this method and the previous method include two different elements, so that a process for combining the two elements is required during installation, and one of the two elements is easy to get lost during installation or detachment, which is troublesome in the installation process.

A one-piece fixing device may be used to avoid the troubles of the two-piece fixing device, which includes a body, with at least one protruding hook being disposed on one side of the body, wherein the hook is inserted into the fastening hole, and then snaps with the opposite surface of the plate to generate a holding effect, so as to fix an object predetermined to be fixed on the plate with the body, thereby combining the object on the plate. However, the one-piece fixing device must match the thickness of the plate, i.e., the distance between the front end of the hook and the body must match the thickness of the plate. If the thickness of the plate is less than the distance between the front end of the hook and the body, a gap is formed between the body and the plate, which may cause the fixing device to sway and shift with respect to the plate, such that the hook cannot snap with the opposite surface of the plate firmly, and thereby the fixing device drops off possibly. Therefore, it is necessary to prepare different one-piece parts for plates of various thicknesses, resulting in troubles of materials management.

### SUMMARY OF THE INVENTION

A conventional fixing device cannot be adapted for plates of different thicknesses, so that fixing devices with different size specification must be prepared for different plates. In view of the above problem, a main object of the present invention is to provide a fixing device, which is suitable for plates of different thicknesses, and is used for fixing an object on a plate.

Therefore, to achieve the above object, the present invention discloses a fixing device comprising a long rectangular sheet-shaped body, wherein a plurality of hooks is vertically disposed at the center part of a surface of the body; a bulge is formed at the front end of each of the hooks. A plurality of elastic arms extending in the horizontal direction are suspended at the side edge of the body. A holding block is formed at the end of each elastic arm. Each elastic arm provides the elastic force after bending for the holding block, so that the holding block is pushed in the opposite direction under the pushing force transferred from the elastic force. When each hook is inserted into a fastening hole on a plate, the holding block is pushed by the elastic force generated from each elastic arm and leans against a surface of the plate. After each hook passes through the fastening hole, the bulge of each hook is snapped with the other surface of the plate, such that the holding block and bulge are clamped with the plate, and thereby, the fixing device is firmly fastened to the plate to fix an object on the surface of the plate.

The efficacy of the present invention lies in that the plate is elastically clamped by the holding block and the bulge at both side surfaces of the plate, respectively; and each elastic arm can be appropriately bent in harmony with the thickness of the plate, such that the holding block leans against the plate firmly. Thus, the present invention is suitable for plates of various thicknesses and achieves a firm fastening effect.

To further understand the objects, structures, features, and functions of the present invention, the present invention is described below in detail through embodiments.

Further scope of applicability of the present invention will become apparent from the detailed description given hereinafter. However, it should be understood that the detailed description and specific examples, while indicating embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 and FIG. 2 are perspective views of a first embodiment of the present invention;

FIG. 3 is a schematic view of an application of the first embodiment;

FIG. 4 is a side view of the first embodiment;

FIG. 5 and FIG. 6 are schematic cross-sectional views of the first embodiment;

FIG. 7 is a schematic cross-sectional view of the first embodiment being applied to plates of different thicknesses;

FIG. 8 is a perspective view of a second embodiment of the present invention;

FIG. 9 is a schematic cross-sectional view of the second embodiment of the present invention; and

FIG. 10 is schematic cross-sectional view of the second embodiment being applied to plates.

### DETAILED DESCRIPTION OF THE INVENTION

The present invention provides a fixing device used by being fastened to a plate, such that an object, for example a signal wire, a decoration item, a antenna, or another plate may be fixed on the plate.

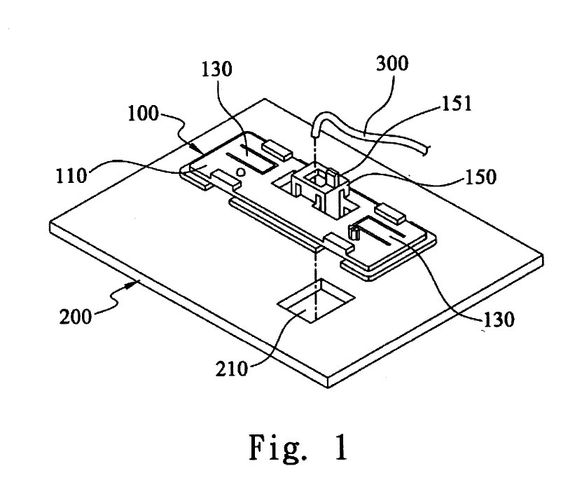

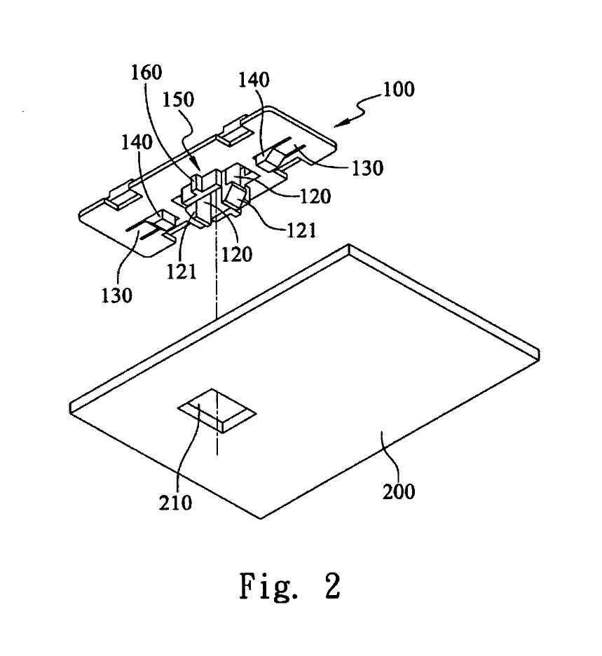

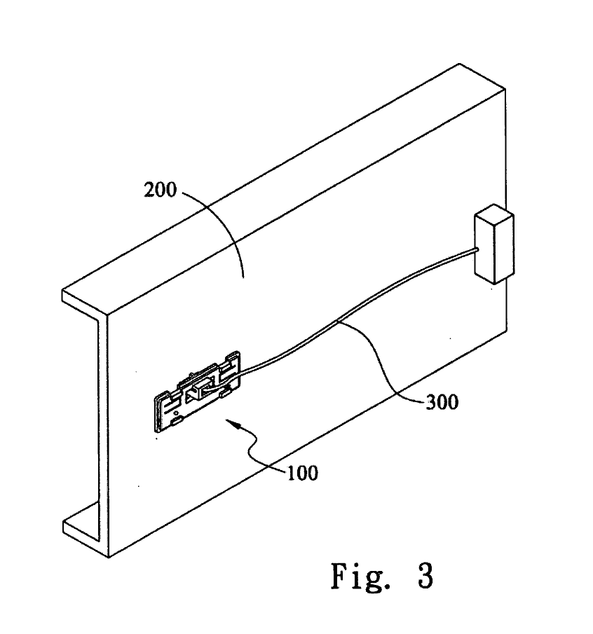

Referring to FIG. 1 to FIG. 3, they show a fixing device 100 used to be fastened to a plate 200 according to a first embodiment of the present invention.

The fixing device 100 comprises a body 110, two hooks 120, two elastic arms 130, and two holding blocks 140.

The body 110 can be formed into various forms, for example, sheet-shaped, columnar or rectangular block. In this embodiment, the body 110 is a long rectangular plate.

The two hooks 120 are vertically disposed on a surface of the body 110, and located at the center part of the body 110, being parallel to each other, and are spaced by a predetermined distance. A bulge 121 is formed at the front end of each hook 120, and two bulges 121 are respectively extended away from each other along the direction vertical to the two hooks 120.

The two elastic arms 130 respectively extend in the horizontal direction towards to the center part of the body 110 from two shorter sides of the body 110, thus forming an aspect of suspending at the body 110.

The two holding blocks 140 are respectively located at the ends of the two elastic arms 130 and located on the same surface of the body 110 as the two hooks 120. The two elastic arms 130 provides the elastic force after bending for the holding blocks 140, so that the holding blocks 140 are pushed towards a opposite direction by the pushing force transferred from the elastic force.

A fixing unit 150 is further disposed on the other surface of the body 100. In this embodiment, the fixing unit 150 is used to fix a cable 300, and the cable 300 is provided for transmission or function as a antenna utilized to improve the receiving of wireless signals. A holder 151 is formed on the top of the fixing unit 150, and is used to fix the cable 300 on the top of the fixing unit 150.

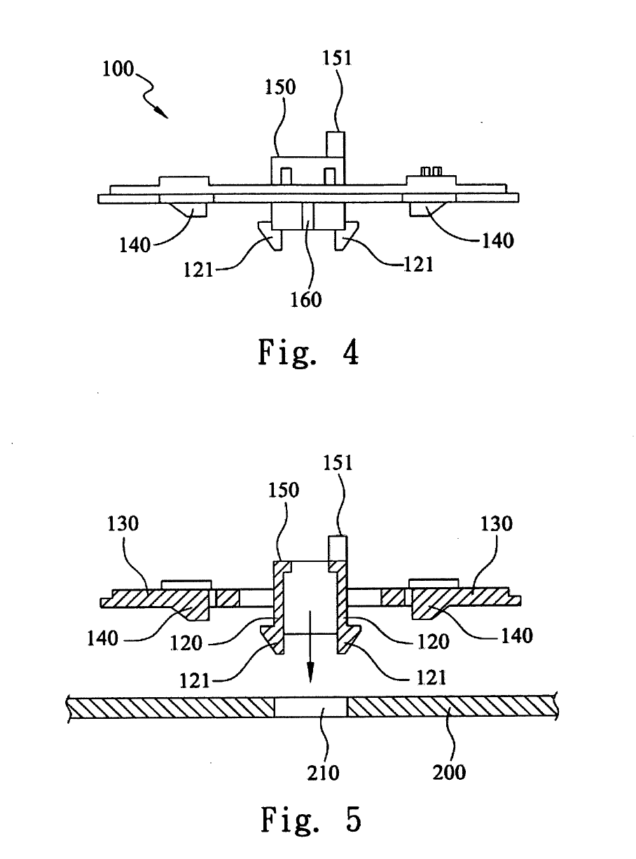

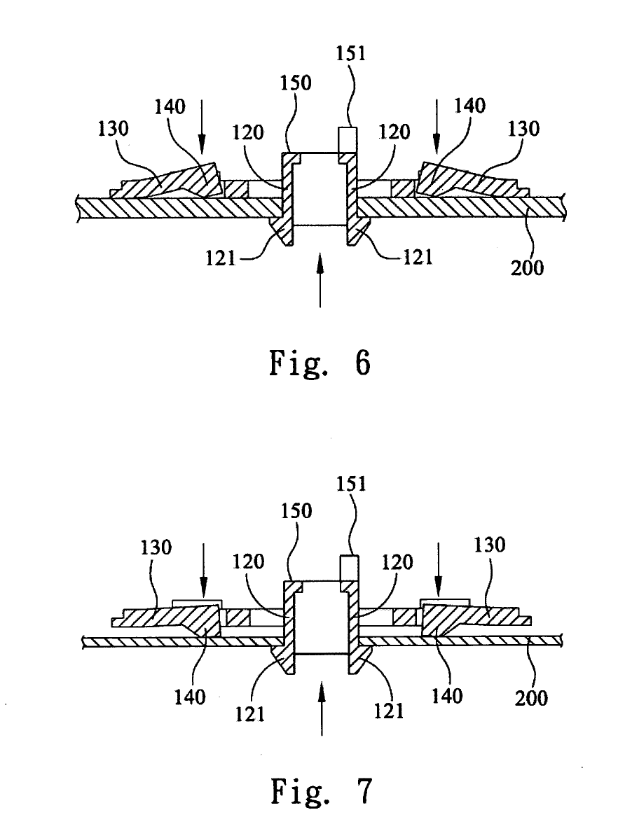

Referring to FIG. 4 and FIG. 6, FIG. 4 is a side view of the fixing device 100, and FIG. 5 and FIG. 6 are schematic cross-sectional views of the fixing device 100 and the plate 200, wherein a method of fastening the fixing device 100 and the plate 200 together is shown.

A fastening hole 210 dug on the plate 200 is used to fasten the fixing device 100. The fastening hole 210 is a long rectangular hole with a length being less than the distance between the two bulges 121. When the two hooks 120 are inserted into the fastening hole 210, the two bulges 121 are squeezed by the fastening hole 210, such that the two hooks 120 are elastically deformed, and the distance between the two bulges 121 is reduced, and thereby, the two bulges 121 can pass through the fastening hole 210. After the bulges 121 pass through the fastening hole 210 and protrude over the opposite surface of the plate 200, the two bulges 121 are spread and extended towards both sides due to the elastic force from the two hooks 120, so as to generate a stopping effect. Thus, the two hooks 120 are snapped with the opposite surface of the plate 200 to prevent the two hooks 120 from withdrawing from the fastening hole 210. During the two hooks 120 pass through the fastening hole 210, the two holding blocks 140 also press against the surface of the plate 200, such that the two elastic arms 130 are bent and deformed to generate the elastic force, and thereby the pushing force is generated by the two holding blocks 140 for pushing the body 110 towards the opposite direction. Thus, the two bulges 121 are firmly snapped with the other surface of the plate 200. As such, the holding blocks 140 and bulges 121 clamp the plate 200 firmly from both sides of the plate 200 to prevent the fixing device 100 from swaying in the direction vertical to the plate 200 and to fix the fixing device 100 firmly on the plate 200. Additionally, to prevent the fixing device 100 from shifting in the direction parallel to the plate 200, two stoppers 160 are further disposed at both sides of the two hooks 120 in this embodiment, wherein the two stoppers 160 have a size matching with that of the fastening hole 210 respectively, and properly lean against two side edges of the fastening hole 210, for preventing the fixing device 100 from shifting in the direction parallel to the plate 200, such that the fixing device 100 is more firmly fixed.

The present invention is characterized in that, as for the fixing device 100, the plate 200 is elastically clamped by the bulges 121 and the holding blocks 140, such that no gap for shifting appears when the fixing device 100 is fastened with the plate 200; and the fixing device 100 also can be fastened to plates 200 of different thickness, such that the fixing effect is not influenced by the relatively small thickness of the plate 200.

Referring to FIG. 7, it shows the first embodiment when being applied on a plate 200 with a relatively small thickness. In FIG. 6, the distance between the two bulges 121 and the body 110 is approximately equal to the thickness of the plate 200, such that the body 110 and the two bulges 121 are tightly attached to the two surfaces of the plate 200 to firmly fasten the fixing device 100 to the plate 200. In FIG. 7, the thickness of the plate 200 is less than the distance between the two holding blocks 121 and the body 110, such that a gap still occurs between the body 110 and the plate 200 after the two hooks 120 are inserted into the fastening hole 210. At this time, the holding blocks 140 replace the body 110 and lean against the surface of the plate 200 due to the elastic force from the two elastic arms 130, such that the plate 200 is hold by both the holding blocks 140 and the two bulges 121, and thereby achieving a firm clamping effect.

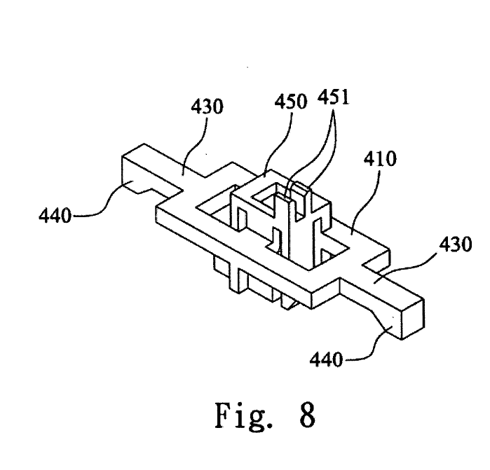

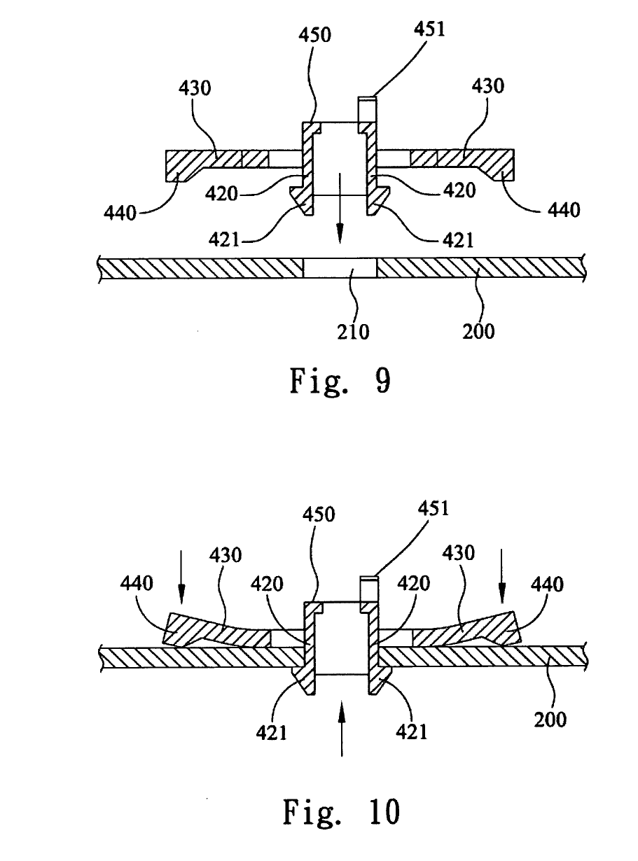

Referring to FIGS. 8 to 10, they show a fixing device 400 according to a second embodiment of the present invention. The fixing device 400 comprises a body 410, two hooks 420, two elastic arms 430, two holding blocks 440, and a fixing unit 450. The two hooks 420 are vertically disposed on a surface of the body 410, and located on the center part of the body 410. The two hooks 420 protrude from the surface of the body 410, being parallel to each other, and are spaced by a predetermined distance. A bulge 420 is formed at the front end of each hook 421, and the two bulges 421 are respectively extended away from each other in the direction being vertical to the two hooks 420. A fixing unit 450 is disposed on the other surface of the body, which has two holders 451 for clamping and holding an object.

The main difference between this embodiment and the first embodiment lies in that, the two elastic arms 130 respectively extend outwards from two shorter sides of the body 110, thus forming into a cantilever beam aspect. The two holding blocks 440 are located at the ends of the two elastic arms 430 respectively, and are located on the same surface of the body 410 as the two hooks 420.

When the two hooks 420 pass through the fastening hole 210 of the plate 200, the two holding blocks touch a surface of the plate 200. The two elastic arms 430 are bent and deformed to generate an elastic force, such that a pushing force is generated by the two holding blocks 440 for pushing the body 410 towards an opposite direction. Thus, the two bulges 421 are firmly snapped with the opposite surface of the plate 200. Therefore, a clamping state is formed by the holding blocks 400 and the bulges 421, and the plate 200 is clamped at two surfaces, and thereby the fixing device 400 is firmly fastened to the plate 200.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A fixing device, comprising:
a body, with a plurality of elastic arms extending in a horizontal direction, wherein a holding block is provided at an end of each of the elastic arms; and
a plurality of hooks, vertically disposed on one side surface of the body.

2. The fixing device as claimed in claim 1, wherein the body is a plate.

3. The fixing device as claimed in claim 1, wherein a bulge is formed at a front end of each of the hooks and extends along a direction vertical to each of the hooks and away from each other.

4. The fixing device as claimed in claim 1, wherein the number of the hooks is two.

5. The fixing device as claimed in claim 4, wherein the two hooks are located at a center part of the body, being parallel to each other and spaced by a predetermined distance.

6. The fixing device as claimed in claim 1, wherein each of the elastic arms extends towards to the center part of the body, forming an aspect of suspending at the body.

7. The fixing device as claimed in claim 1, wherein each of the elastic arms extends outwards.

8. The fixing device as claimed in claim 1, wherein the body has a fixing unit.

9. The fixing device as claimed in claim 8, wherein the fixing unit has a holder.

10. The fixing device as claimed in claim 8, wherein the fixing unit has two holders.
